(19) United States
(12) Patent Application Publication
(10) Pub. No.: US 2023/0385113 A1
(43) Pub. Date: Nov. 30, 2023

(54) Progress Monitoring Service

(71) Applicant: MICROSOFT TECHNOLOGY LICENSING, LLC, Redmond, WA (US)

(72) Inventor: Max DYMOND, Kings Lynn (GB)

(21) Appl. No.: 17/873,093

(22) Filed: Jul. 25, 2022

(30) Foreign Application Priority Data
May 25, 2022 (GB) 2207679.8

(51) Int. Cl. G06F 9/50

(52) U.S. Cl. CPC G06F 9/5027

(57) ABSTRACT

A progress monitoring service for monitoring progress of a task. The method comprises receiving, from a process manager managing the task, a request for a task identifier. The progress monitoring service returns an identifier to the process manager. The progress monitoring service receives, from a system used to carry out at least part of the task, the identifier and progress data about progress of the task. The progress monitoring service updates a web page with the progress data and makes the web page available to an end user of the process manager.

### CROSS-REFERENCE TO RELATED APPLICATION(S)

This non-provisional utility application claims priority to UK patent application number 2207679.8 entitled “PROGRESS MONITORING SERVICE” and filed on 25 May 2022, which is incorporated herein in its entirety by reference.

### BACKGROUND

Processes for deploying services in the cloud, life cycle management of deployed cloud services and others are in demand as a result of the widespread adoption of cloud computing technologies. Cloud services are used for many types of situation including voice over interne protocol services and others.

The embodiments described below are not limited to implementations which solve any or all of the disadvantages of known monitoring services.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

In various examples there is a computer-implemented method performed by a progress monitoring service for monitoring progress of a task. The method comprises receiving, from a process manager managing the task, a request for a task identifier. The progress monitoring service returns an identifier to the process manager. The progress monitoring service receives, from a system used to carry out at least part of the task, the identifier and progress data about progress of the task. The progress monitoring service updates a web page with the progress data and makes the web page available to an end user of the process manager.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a progress monitoring service;

FIG. 2 is a schematic diagram of a graphical user interface of a progress monitoring service;

FIG. 3 is a message sequence chart showing use of a progress monitoring service;

FIG. 4 is another message sequence chart showing use of a progress monitoring service;

FIG. 5 is a flow chart of an example method performed by a progress monitoring service;

FIG. 6 is a flow chart of an example method performed by a process manager;

FIG. 7 illustrates an exemplary computing-based device in which embodiments of a process monitoring service and/or process manager are implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples are constructed or utilized. The description sets forth the functions of the examples and the sequence of operations for constructing and operating the examples. However, the same or equivalent functions and sequences may be accomplished by different examples.

As mentioned in the background section, processes for deploying services in the cloud, life cycle management of deployed cloud services and others are in demand as a result of the widespread adoption of cloud computing technologies. Computer implemented process managers are usable to manage such processes in an automated manner.

A non-exhaustive list of examples of process managers is: GITOPS (trade mark), Jenkins (trade mark), Bitbucket pipelines (trade mark), CircleCi (trade mark), Atlantis (trade mark). A process manager has an associated source code repository that contains declarative descriptions of infrastructure desired in a production environment of a cloud service. A process manager is an automated process for making a production environment agree with declarative descriptions in an associated source code repository. The automated process carries out a task. Each task uses one or more systems. A non-exhaustive list of examples of systems is: cloud computing service, Azure (trade mark). A non-exhaustive list of examples of tasks is: deploying a cloud service, validating configuration of a cloud service, creating a resource group, creating a network security group, deploying a virtual machine, deletion of resources, carrying out life cycle management of a cloud service, deploying a voice mail service.

During the time when a process manager is managing a task, an end user, such as an operator or developer, has little feedback about progress of the task. The task often takes several minutes, hours or days to complete and the end user is unaware of how the process is progressing until the process terminates due to successful completion or due to failure. Where the task comprises using one or more systems (such as Azure (trade mark) or other cloud services) complexity and latency is introduced. The systems may be remote with respect to the process manager. Contentions on the various systems means that the length of time to complete a task varies as the level of contention varies. The systems are typically inscrutable, that is, do not provide information about their progress on a given task to the process manager. The end user can be left in a difficult and frustrating situation where the process manager spends significant time on a task and then fails. The result is wasted computing resources, power and time. It is difficult for the end user to anticipate problems with the process and take any corrective action.

By using a progress monitoring service as described herein it is possible for an end user to visualize progress of tasks being managed by a process manager. The progress monitoring service updates a web page with progress data received from one or more systems used by the process manager to carry out the task. By using identifiers it is possible to manage the progress data effectively and efficiently.

The progress monitoring service monitors progress of a task. The progress monitoring service receives, from a process manager managing the task, a request for a task identifier. The progress monitoring service returns an identifier to the process manager. The process manager is then able to send the identifier to any systems which will be used in the task. The progress monitoring service receives, from one or more systems used to carry the task, the identifier and progress data about progress of the task.

Because the progress data is with the identifier the progress monitoring service is able to know what task the progress data is about, even though there are potentially lots of different tasks and items of progress data. The progress monitoring service updates a web page with the progress data and makes the web page available to an end user of the process manager. By using a web page the end user has an efficient and effective way to obtain the progress data from any device with a web browser. In this way an end user is able to gain progress data about progress of a task in an efficient and effective manner.

The task is completed by reaching a plurality of milestones each having an associated event. In an example the task is to create a network security group and there are four events in the task as follows: start the process, create network security group, stop creating network security group, finish the task. The process manager associates the task identifier with the events and the order of the events. The events and the order of the events is referred to as a task description.

In an example the progress monitoring service is for monitoring progress of a task, the progress monitoring service and the task executing in a computing network of a cloud computing system comprising a plurality of computing devices. The progress monitoring service receives, from a process manager managing the task, a request for a task identifier, the task identifier identifying the task, wherein the process manager is configured to modify a production environment to conform with declarative descriptions in an associated source code repository, and wherein the task is associated with modifying the production environment to conform with the declarative descriptions. The task identifier is returned to the process manager. The process manager sends the task identifier to a system executing at least part of the task. The progress monitoring service receives, from the system executing at least part of the task, the task identifier and progress data indicative of a progress of the task. Using an association of the progress data and the task identifier, the progress monitoring service updates a user interface with the progress data indicative of the progress of the task.

In some examples the identifier is unique per instance of a task. By using an identifier which is unique per instance of a task it is possible to separate progress data by task instance despite having potentially lots of systems returning progress data about lots of tasks.

In some examples the progress monitoring service has a learning mode for learning task descriptions. So receiving the task comprises receiving either a task with events specified by an end user or receiving a task and events which were learnt from historical data during the learning mode. By having a learning mode it is possible to learn task descriptions which are then publishable for use by end users. During a learning mode, the progress monitoring service identifies events from the progress data which have the same identifier and stores and/or publishes a task having the identified events.

After the identifier is returned to the process manager, the process manager sends the identifier to the system(s) which are involved in the task. The systems are configured to send progress data about the task, together with the identifier, to the progress monitoring service. This is done by posting an HTTP message to the progress monitoring service or in other ways.

The progress monitoring service receives, from a plurality of systems used to carry out the task, the identifier and progress data about progress of the task. Using the identifiers the progress monitoring service is able to collate progress data per task.

A given system may use one or more sub-systems. Where a sub-system is used the progress monitoring sub-system receives, from a sub-system used to carry out at least part of the task, the identifier and progress data about progress of the task. The sub-system has received the identifier from the system of which it is a sub-system.

In examples, the request for the task identifier is part of an HTTP request. By using HTTP an efficient, effective way of communicating between the progress monitoring service and process manager is achieved.

In an example, updating the web page with the progress data comprises updating a progress bar according to events of the task which are completed. Progress bars give a straightforward status indication to an end user about status of the internal operation of the systems. The progress bars are assessed by an end user at a glance and facilitate prompt decision making in the event a user is to take corrective action by changing or modifying the process being managed to avoid a bottleneck which is identified by the progress bars.

In some cases updating the web page comprises displaying a plurality of progress bars, one for the task and one for each of a plurality of previous tasks of the same type as the task. Using a plurality of progress bars enables an end user to quickly assess progress of the current task and to compare that with past performance.

In some examples the process manager is arranged to trigger an alert on the basis of the progress data. The alert notifies an operator who is able to take action to modify the process being managed.

In some examples the process manager is configured to take automated corrective action on the basis of the progress data. Corrective action may comprises modifying the process being managed and/or changing the system(s) used to carry out the task. In this way computing resources and time are saved since it is not necessary to wait until the process fails or completes before taking corrective action.

The process manager is configured to request an identifier for a task from a progress monitoring service. It receives the identifier and sends the identifier to one or more systems for carrying out the task. The process manager is able to query the progress monitoring service to obtain progress data. The progress data is fine grained and informs about the state of the systems. In some cases, the process manager is able to compare the progress data with a threshold and, in response to the comparison, trigger an alert and/or take automated corrective action.

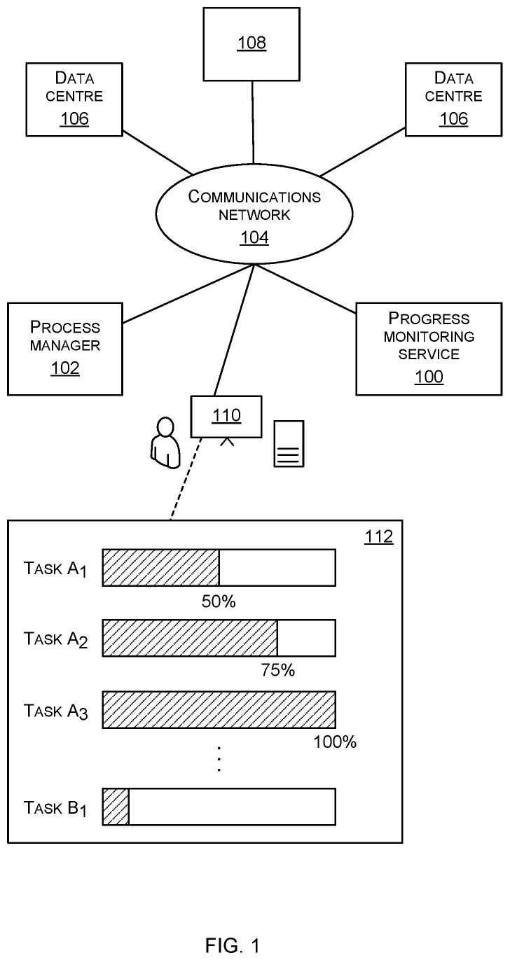

FIG. 1 is a schematic diagram of a progress monitoring service 100 which is a web service or other service connected to a communications network 104 such as the Internet, an intranet, or any other communications network. The progress monitoring service is computer implemented and receives and collates progress data from one or more systems such as cloud services deployed in data centers 106, compute nodes 108 or other computing systems connected to communications network 104. The progress monitoring service allocates identifiers to task instances as described in more detail below.

A process manager 102 is also connected to communications network 104 and manages a process for carrying out a task using one or more of the systems. The process manager 102 is computer implemented. The systems are configured to send progress data about their progress on the task to the progress monitoring service 100 together with task identifiers. The process manager 102 informs the appropriate systems of the appropriate identifiers obtained from the progress monitoring service 100.

An end user operating a computing device 110 such as a desk top computer is able to view a graphical user interface 112 of the progress monitoring service 100. The graphical user interface 112 has one or more progress bars, one per task instance. In the example of FIG. 1 there are four progress bars, one progress bar for each of three instances of task A and one progress bar for an instance of task B. The progress bars give a graphical indication of a percentage completion of a task. The progress bars provide an insight into the state of the systems being used to carry out the respective tasks. Using the progress bars an end user is quickly able to spot problems such as bottlenecks in the systems where progress becomes much slower than previously observed or slower than a threshold.

The progress monitoring service of the disclosure operates in an unconventional manner to achieve monitoring of progress of tasks of the disclosure.

The progress monitoring service improves the functioning of the underlying computing system by enabling status of systems being used to carry out a task to be determined.

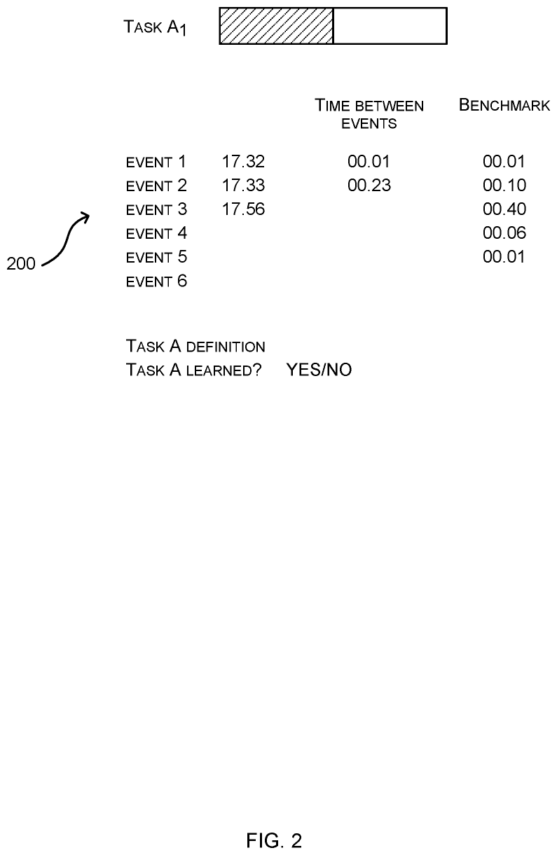

FIG. 2 is a schematic diagram of a graphical user interface 200 of a progress monitoring service. The graphical user interface has a progress bar for an instance of task A which in this example is 50% complete. The graphical user interface shows 6 events which form task A and shows a time at which events 1, 2 and 3 were completed. The times of the events being completed is known from the progress data received at the progress monitoring service from the one or more systems which are used to carry out the task. The graphical user interface shows the time between events and also shows a benchmark time between events for consecutive pairs of events in the task. The benchmark times are computed by the progress monitoring service from historical data.

The graphical user interface also has a definition of task A such as a text description of what the task is and a text description of each of the six events.

The graphical user interface includes an indication of whether task A is a learned task or not. More detail about learned tasks is given later.

The graphical user interface provides information about the status of the systems being used to carry out the task in a clear and efficient manner.

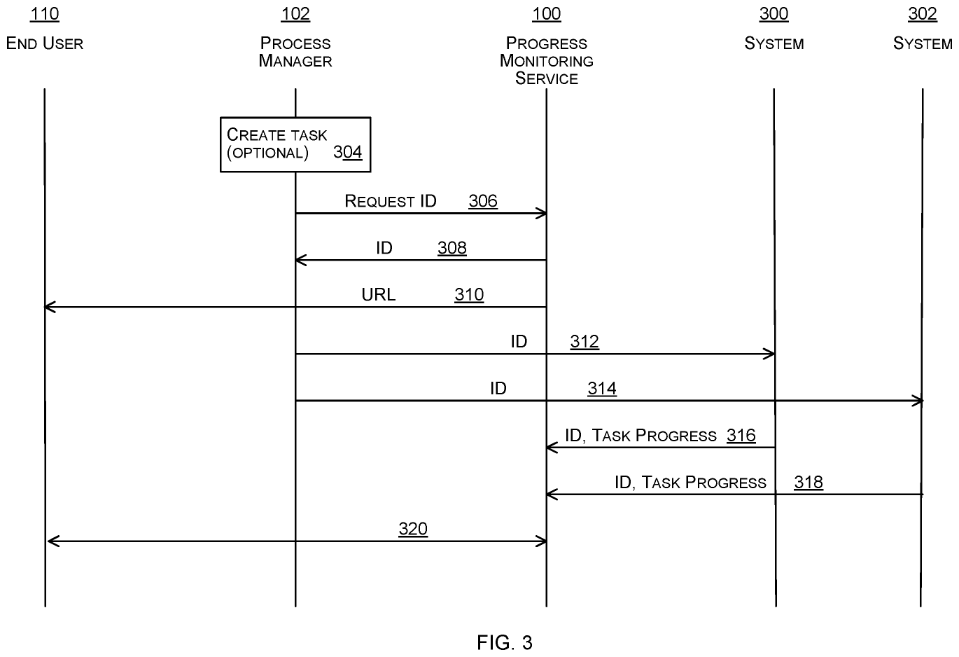

FIG. 3 is a message sequence chart showing use of a progress monitoring service 100. Each vertical line in FIG. 3 represents an entity as indicated and the horizontal arrows between the vertical lines represent messages sent between the entities. The relative vertical position of the horizontal arrows represents chronological order.

The process manager sends a request 306 for an ID to the progress monitoring service 100. The requested ID is for an instance of a task and the task is specified in the request 306. In some cases the task is created 304 by the process manager, such as by an end user 110 specifying the task and specifying events and an order of events within the task. In some cases the task is a published task description (comprising events and an order of the events) which has been published by the progress monitoring service.

The progress monitoring service allocates an identifier to the task instance and stores a record of the identifier and associated task instance. The progress monitoring service sends the ID to the process manager using message 308. In some cases the allocated identifier is unique in that the progress monitoring service has not allocated the identifier to any other instance of the task.

The progress monitoring service optionally sends 310 a uniform resource locator URL to the end user 110 using an address of the end user 110 provided by the process manager 102. However, it is not essential to do this since in some cases the URL is publicly known and available to the end user via search engines or other sources.

The process manager 102 knows which system 300 or systems are to be used to carry out the task since these are obtained from a domain name service or are configured by an operator. In the example of FIG. 3 two systems are used 300, 302. However, it is possible to use only one system or to use more than two systems.

Each system to be used is sent the ID by the process manager 102. Thus system 300 receives message 312 with the ID and system 302 receives message 314 with the ID. The systems are configured to send progress data together with the respective ID to the progress monitoring service 100. Thus system 300 sends progress data and the ID to the progress monitoring service 100 using message 316. System 302 sends progress data and the ID to the progress monitoring service 100 using message 318.

The progress data is information about occurrence of the events which form the task. The progress data may comprise times when the events occur. The progress data may comprise information about success or failure of the events.

The progress monitoring service 100 stores the progress data and uses it to update a web page or graphical user interface, such as by updating progress bars such as those shown in FIG. 1 and FIG. 2.

FIG. 3 illustrates how the IDs are used by the progress monitoring service to identify progress data pertaining to a particular instance of a task. In this way fine grained status data is made available via the progress monitoring service in an efficient and effective manner.

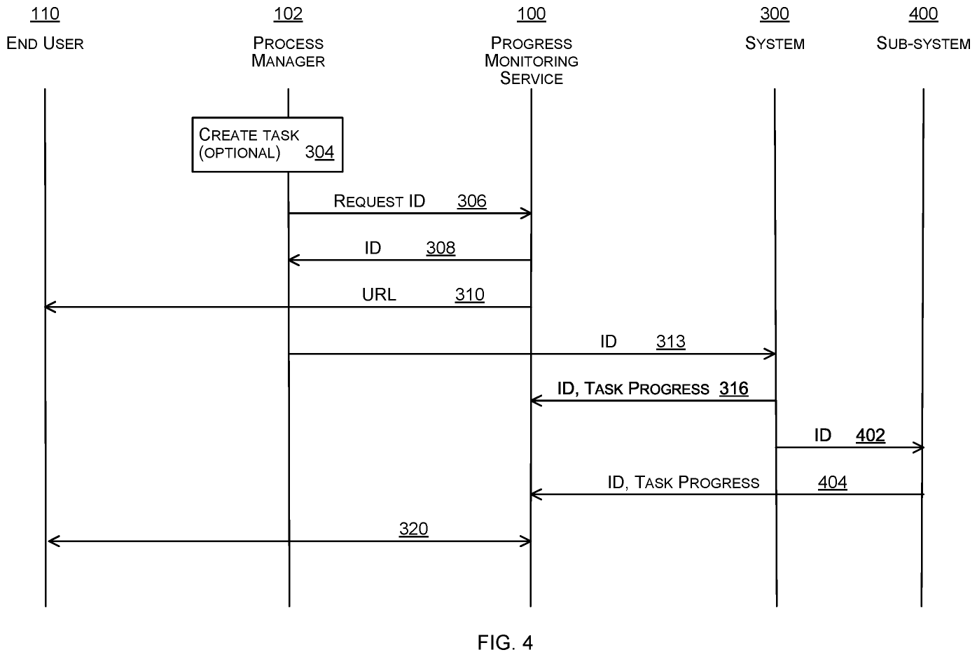

FIG. 4 is another message sequence chart showing use of a progress monitoring service. FIG. 4 is similar to FIG. 3 except that system 300 with a sub-system 400 is used.

Each vertical line in FIG. 4 represents an entity as indicated and the horizontal arrows between the vertical lines represent messages sent between the entities. The relative vertical position of the horizontal arrows represents chronological order.

The process manager 102 sends a request 306 for an ID to the progress monitoring service 100. The requested ID is for an instance of a task and the task is specified in the request 306. In some cases the task is created 304 by the process manager, such as by an end user 110 specifying the task and specifying events and an order of events within the task. In some cases the task is a published task description (comprising events and an order of the events) which has been published by the progress monitoring service.

The progress monitoring service allocates an identifier to the task instance and stores a record of the identifier and associated task instance. The progress monitoring service sends the ID to the process manager using message 308. In some cases the allocated identifier is unique in that the progress monitoring service has not allocated the identifier to any other instance of the task.

The progress monitoring service optionally sends 310 a uniform resource locator URL to the end user 110 using an address of the end user 110 provided by the process manager 102. However, it is not essential to do this since in some cases the URL is publicly known and available to the end user via search engines or other sources.

The process manager 102 knows which system 300 or systems are to be used to carry out the task since these are obtained from a domain name service or are configured by an operator. In the example of FIG. 4 one system is used 300. System 300 in this example has a sub-system 400.

The system 300 is sent the ID by the process manager 102. However, the process manager 102 does not know about sub-system 400 and so cannot send the ID to sub-system 400. System 300 sends the ID to the sub-system 400 using message 402.

System 300 sends progress data and the ID to the progress monitoring service 100 using message 316. Sub-system 400 sends progress data and the ID to the progress monitoring service 100 using message 404. The sub-system 400 has been configured to send progress data to the progress monitoring service 100.

The progress data is as for FIG. 3.

The progress monitoring service 100 stores the progress data and uses it to update a web page or graphical user interface, such as by updating progress bars such as those shown in FIG. 1 and FIG. 2.

FIG. 4 illustrates how the IDs are used even in the case of a sub-system. In the example of FIG. 4 there is one sub-system. It is possible to modify FIG. 4 by adding more layers of nesting; that is sub-system 400 is able to have its own sub-system. It is possible to combine the arrangements of FIG. 3 and FIG. 4; that is to have more than one system and with more than one of the systems having one or more sub-systems.

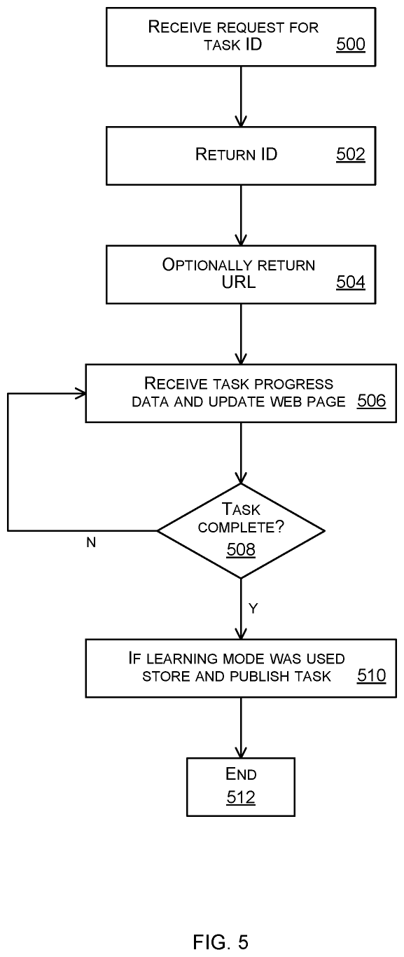

FIG. 5 is a flow chart of an example method performed by a progress monitoring service such as that of FIG. 1. The progress monitoring service receives 500 a request for an ID for an instance of a task. The progress monitoring service returns an ID at operation 502 to the requesting entity. The progress monitoring service optionally returns 504 a URL to the requesting entity or to an end user. The URL is an address of a web page with progress data.

The progress monitoring service receives task progress data from one or more systems which carry out the task. The progress monitoring service uses the progress data to update 506 the web page.

The progress monitoring service checks whether the task is complete at check 508 and if not continues to receive task progress data 506. The check at operation 508 comprises checking for stopping criteria such as a specified duration of time since a last item of progress data was received, receipt of progress data indicating completion of a final event of a task or other criteria.

If the task is determined to be complete at operation 508 the progress monitoring service checks whether a learning mode was used. If so, it stores and publishes a task description, comprising the task, events of the task and an order of the events. The process ends at operation 512.

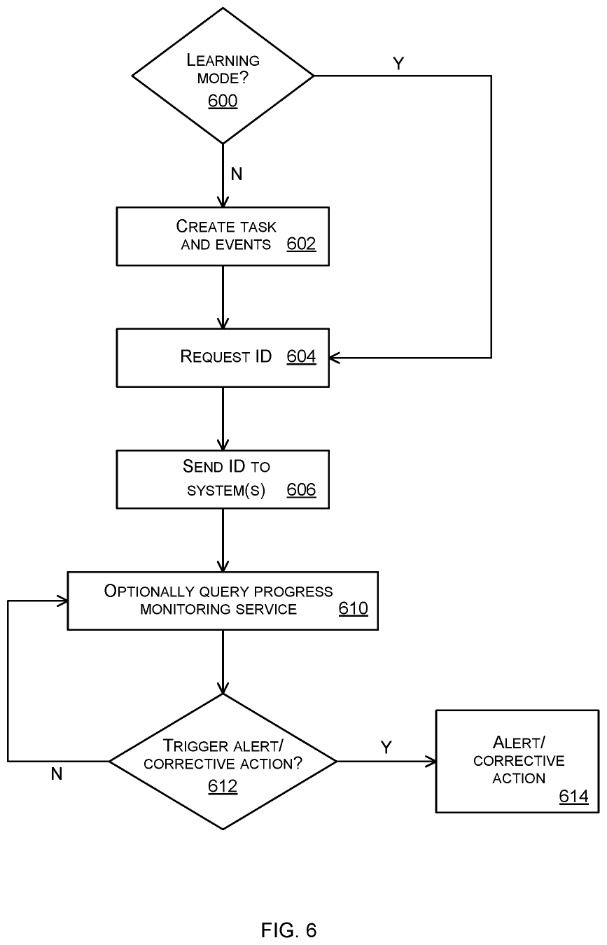

FIG. 6 is a flow chart of an example method performed by a process manager such as that of FIG. 1. The process manager checks whether a learning mode is current at operation 600. This is done by checking for a flag being set as a result of user input or in other ways. If learning mode is not current the process manager creates a task and events at operation 602. The task and events are created by being received from an end user or being retrieved from a published task.

The process manager requests 604 an ID for an instance of the task from the progress monitoring service. It receives an ID in response to the request. It sends 606 the ID to one or more systems which are to carry out the task.

The process manager optionally queries 610 the progress monitoring service with the ID to obtain progress data about the task instance. The progress monitoring service determines 612 whether to trigger an alert and/or trigger corrective action 612. If not it continues to query the progress monitoring service 610. The check at operation 612 comprises using rules and/or thresholds. The progress data is compared with a threshold or benchmark data and on the basis of the comparison a decision is made whether to trigger an alert and/or corrective action. In an example, where the progress data comprises a difference in time between two consecutive events of a task which is above a threshold then an alert and/or corrective action is triggered. In an example, where the progress data comprises a time duration which is above a threshold then an alert and/or corrective action is triggered.

Where an alert is triggered 614 an end user is sent a message.

Where corrective action is triggered the process manager changes one or more of the systems used to carry out the task and/or changes the process.

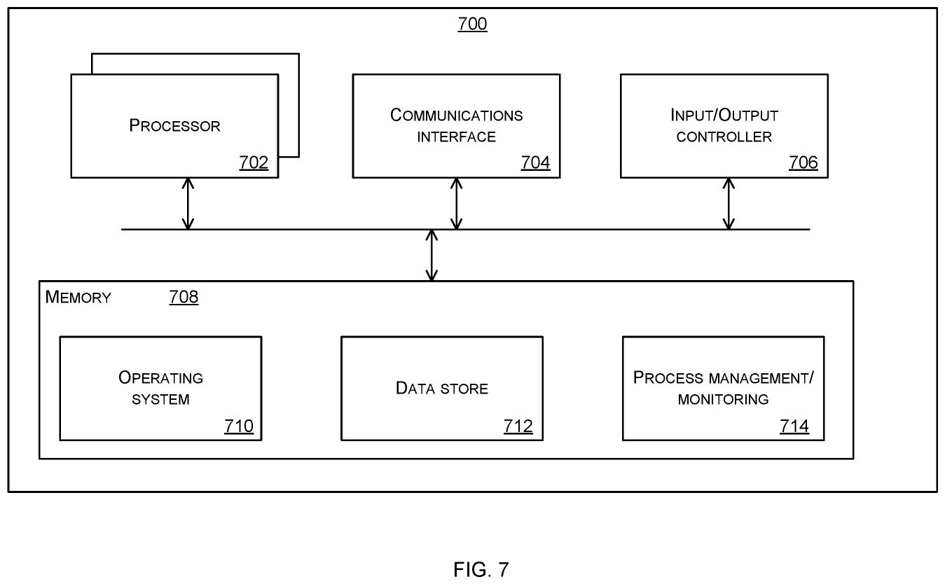

FIG. 7 illustrates various components of an exemplary computing-based device 700 which are implemented as any form of a computing and/or electronic device, and in which embodiments of a process monitoring and/or process management function are implemented in some examples.

Computing-based device 700 comprises one or more processors 702 which are microprocessors, controllers or any other suitable type of processors for processing computer executable instructions to control the operation of the device in order to implement the method of any of FIGS. 3 to 6. In some examples, for example where a system on a chip architecture is used, the processors 702 include one or more fixed function blocks (also referred to as accelerators) which implement a part of the method of any of FIGS. 3 to 6 in hardware (rather than software or firmware). Data store 712 holds task descriptions, events, statistics, thresholds, rules or other data. A process monitoring function and/or process management function 714 is provided at the computing-based device. Platform software comprising an operating system 710 or any other suitable platform software is provided at the computing-based device to enable application software to be executed on the device such as process monitoring function and/or process management function 714.

The computer executable instructions are provided using any computer-readable media that is accessible by computing based device 700. Computer-readable media includes, for example, computer storage media such as memory 708 and communications media. Computer storage media, such as memory 708, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 708) is shown within the computing-based device 700 it will be appreciated that the storage is, in some examples, distributed or located remotely and accessed via a network or other communication link (e.g. using communication interface 704).

The computing-based device 700 also comprises an input/output controller 706 arranged to output display information to a display device which may be separate from or integral to the computing-based device 700. The display information provides a graphical user interface such as that illustrated in FIG. 1 and FIG. 2 for displaying progress monitoring statistics, progress bars and other data. The input/output controller 706 is also arranged to receive and process input from one or more devices, such as a user input device (e.g. a mouse, keyboard, camera, microphone or other sensor). In some examples the user input device detects voice input, user gestures or other user actions and provides a natural user interface (NUI). This user input may be used to trigger display of progress bars, trigger display of statistics, set thresholds, specify corrective actions and for other purposes. In an embodiment the display device also acts as the user input device if it is a touch sensitive display device.

Alternatively, or in addition to the other examples described herein, examples include any combination of the following:

A computer-implemented method performed by a progress monitoring service for monitoring progress of a task, the progress monitoring service and the task executing in a computing network of a cloud computing system comprising a plurality of computing devices, the method comprising:
receiving, from a process manager managing the task, a request for a task identifier, the task identifier identifying the task, wherein the process manager is configured to modify a production environment to conform with declarative descriptions in an associated source code repository, and wherein the task is associated with modifying the production environment to conform with the declarative descriptions;
returning the task identifier to the process manager;
sending, by the process manager, the task identifier to a system executing at least part of the task;
receiving, from the system executing at least part of the task, the task identifier and progress data indicative of a progress of the task;
based on an association of the progress data and the task identifier, updating a user interface with the progress data indicative of the progress of the task.

A computer-implemented method performed by a progress monitoring service for monitoring progress of a task, the method comprising:
receiving, from a process manager managing the task, a request for a task identifier; returning an identifier to the process manager;
receiving, from a system used to carry out at least part of the task, the identifier and progress data about progress of the task;
updating a web page with the progress data; and
making the web page available to an end user of the process manager.

The method of the previous example wherein the task is completed by reaching a plurality of milestones each having an associated event, and wherein the process manager associates the task identifier with the events.

The method of any previous example wherein the identifier is unique.

The method of any previous example wherein receiving the task comprises receiving either a task with events specified by an end user or receiving a task and events which were learnt from historical data.

The method of any previous example comprising, during a learning mode, identifying events from the progress data and storing and publishing a task having the identified events.

The method of any previous example comprising, after the identifier is returned to the process manager, using the process manager to send the identifier to the system.

The method of any previous example comprising, receiving, from a plurality of systems used to carry out the task, the identifier and progress data about progress of the task.

The method of any previous example comprising receiving, from a subsystem used to carry out at least part of the task, the identifier and progress data about progress of the task.

The method of the previous example wherein the sub-system has received the identifier from the system.

The method of any previous example wherein the request for the task identifier is part of an HTTP request.

The method of any previous example wherein updating the web page with the progress data comprises updating a progress bar according to events of the task which are completed.

The method of any previous example wherein updating the web page comprises displaying a plurality of progress bars, one for the task and one for each of a plurality of previous tasks of the same type as the task.

The method of any previous example comprising using the process manager to trigger an alert on the basis of the progress data.

The method of any previous example comprising using the process manager to take automated corrective action on the basis of the progress data.

A progress monitoring service apparatus for monitoring progress of a task, the apparatus comprising a processor having instructions which when executed by the processor perform the operations of:
receiving, from a process manager managing the task, a request for a task identifier;
returning an identifier to the process manager;
receiving, from a system used to carry out at least part of the task, the identifier and progress data about progress of the task;
updating a web page with the progress data; and
making the web page available to an end user of the process manager.

A method of managing a process comprising:
requesting an identifier for a task from a progress monitoring service;
receiving the identifier;
sending the identifier to a system for carrying out the task;

The method of the previous example comprising sending the identifier to a plurality of systems for carrying out the task.

The method of the previous two examples comprising, querying the progress monitoring service to obtain progress data and comparing the progress data with a threshold and, in response to the comparison, triggering an alert.

The method of the previous three examples comprising, querying the progress monitoring service to obtain progress data and comparing the progress data with a threshold and, in response to the comparison, taking automated action to modify the process.

The method of the previous example wherein comparing the progress data with the threshold identifies a bottleneck in the task and wherein the automated action comprises removing the bottleneck.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

What is claimed is:

1. A computer-implemented method performed by a progress monitoring service for monitoring progress of a task, the method comprising:
receiving, from a process manager managing the task, a request for a task identifier;
returning an identifier to the process manager;
receiving, from a system used to carry out at least part of the task, the identifier and progress data about progress of the task;
updating a web page with the progress data; and
making the web page available to an end user of the process manager.

2. The method of claim 1 wherein the task is completed by reaching a plurality of milestones each having an associated event, and wherein the process manager associates the task identifier with the events.

3. The method of claim 1 wherein the identifier is unique.

4. The method of claim 1 wherein receiving the task comprises receiving either a task with events specified by an end user or receiving a task and events which were learnt from historical data.

5. The method of claim 1 comprising, during a learning mode, identifying events from the progress data and storing and publishing a task having the identified events.

6. The method of claim 1 comprising, after the identifier is returned to the process manager, using the process manager to send the identifier to the system.

7. The method of claim 1 comprising, receiving, from a plurality of systems used to carry out the task, the identifier and progress data about progress of the task.

8. The method of claim 1 comprising receiving, from a subsystem used to carry out at least part of the task, the identifier and progress data about progress of the task.

9. The method of claim 8 wherein the sub-system has received the identifier from the system.

10. The method of claim 1 wherein the request for the task identifier is part of an HTTP request.

11. The method of claim 1 wherein updating the web page with the progress data comprises updating a progress bar according to events of the task which are completed.

12. The method of claim 1 wherein updating the web page comprises displaying a plurality of progress bars, one for the task and one for each of a plurality of previous tasks of the same type as the task.

13. The method of claim 1 comprising using the process manager to trigger an alert on the basis of the progress data.

14. The method of claim 1 comprising using the process manager to take automated corrective action on the basis of the progress data.

15. A progress monitoring service apparatus for monitoring progress of a task, the apparatus comprising a processor having instructions which when executed by the processor perform the operations of:
receiving, from a process manager managing the task, a request for a task identifier;
returning an identifier to the process manager;
receiving, from a system used to carry out at least part of the task, the identifier and progress data about progress of the task;
updating a web page with the progress data; and
making the web page available to an end user of the process manager.

16. A method of managing a process comprising:
requesting an identifier for a task from a progress monitoring service;
receiving the identifier;
sending the identifier to a system for carrying out the task;

17. The method of claim 16 comprising sending the identifier to a plurality of systems for carrying out the task.

18. The method of claim 16 comprising, querying the progress monitoring service to obtain progress data and comparing the progress data with a threshold and, in response to the comparison, triggering an alert.

19. The method of claim 16 comprising, querying the progress monitoring service to obtain progress data and comparing the progress data with a threshold and, in response to the comparison, taking automated action to modify the process.

20. The method of claim 19 wherein comparing the progress data with the threshold identifies a bottleneck in the task and wherein the automated action comprises removing the bottleneck.
